(19) United States
(12) Patent Application Publication
(10) Pub. No.: US 2002/0173207 A1
(43) Pub. Date: Nov. 21, 2002

(54) Connecting piece of electrically conducting material, preferably a cable shoe, together with a method for its implementation

(76) Inventor: Ola Pettersen, Lund (SE)

Correspondence Address: JACOBSON HOLMAN PLLC, 400 SEVENTH STREET N.W., SUITE 600, WASHINGTON, DC, 20004, US

(21) Appl. No.: 10/144,794

(22) Filed: May 15, 2002

(30) Foreign Application Priority Data
May 15, 2001 (SE) 0101689-8

(51) Int. Cl. H01R 9/24

(52) U.S. Cl. 439/886

(57) ABSTRACT

The present invention (FIG. 1) relates to a connecting piece (1) of electrically conducting material with a pressed-on soldering clip (4) mounted on a compact plate (5) with a flux material (12), and a method for carrying out the said invention.

The present invention relates to a method for producing a new type of connecting piece of metal or another electrically conducting material, preferably a cable shoe, that is to be joined to another object of metal or another electrically conducting material by means of brazing and in which heat is produced by an electric arc. The shape and construction of the electrically conducting connecting piece prevent the formation of structural changes (martensite formation) underneath the brazed joint. The invention also relates to such a connecting piece, preferably a cable shoe, of metal or another electrically conducting material.

Developments in railway traffic involve ever higher speeds and heavier axle loads. This in turn places increasing demands on the strength of railway track and its ability to withstand wear and accordingly rails are manufactured from higher-alloyed steel in order to meet these more stringent requirements. The material from which rails are manufactured is sensitive to thermal influences that can cause structural changes known as martensite formation (hardening effect).

Martensite formation may lead to crack formation in the rail material and due to the higher loads the rail may fracture, with catastrophic consequences for railway traffic. Consequently it is very important to braz signal and other wiring and cabling firmly to the rail by using a method that does not cause martensite formation in the rail.

Up to now it has only been possible to minimise martensite formation or structural changes by means of a pin brazing method, which is described in Swedish patent 9003708-6 (469 319). Hitherto it has not been possible by any pin brazing method to completely eliminate martensite formation in electrical contact connections that are intended to join two or more objects by means of an electrical connection.

The most serious problem in current pin soldering methods employed on railway track is the large amount of heat that is produced underneath the soldering joint, which is caused by the electric arc that is generated in the soldering process and produces a deleterious structural change or martensite formation. The problem is to a large extent due to the pin soldering method that is currently employed. The flux material and silver solder that are required in the soldering are supplied via a soldering pin that is secured in the soldering gun and that at the same time forms an electrode.

In order to produce a connection between metal surfaces on rails/pipework and cable shoes, the current procedure is to provide a cable shoe with an opening so that flux material and solder material can pass from the soldering pin through the cable shoe and then firmly solder the cable shoe to the flat metal surface. At the start of the soldering process the electric arc acts directly on the rail and produces locally a very high temperature which is then transmitted indirectly via the solder melt and generates high temperatures directly in the rail, which have a deleterious effect on the latter, There is also the risk of an alloying of electrode material in the solder when using conventional pin soldering systems, which has adverse effects on both the soldering and workpiece. The final stage in the currently employed pin soldering involves pressing the soldering pin downwardly into the soldering and then breaking off the pin, which has a negative effect on the soldered joint itself.

Furthermore, a disadvantage of current soldering processes is that both the flux material and solder material are used in order to secure the electrically conducting connecting piece, preferably a cable shoe. Since the soldering process takes place over a short period, a large amount of heat is required which is transmitted from the electric arc via the solder through the cable shoe to the workpiece or rail. The problem has been that a satisfactory secure soldering has to be produced at the same time without causing any structural changes underneath the soldering joint.

At the present time in France, Italy, Switzerland, Spain and Germany it is prohibited to use pin soldering on railway track on account of martensite formation.

Certain other countries where pin soldering on railway track is currently permitted are in the process of changing their requirements and consequently existing pin soldering methods will no longer be allowed to be used in the future.

The present invention relates to a new type of electrically conducting connecting piece of metal or another electrically conducting material, preferably a cable shoe, which involves a new method of temperature-controlled soldering in which the problem of martensite formation that affects other methods is solved.

The invention also relates to a method for implementing this new type of connecting piece of metal or another electrically conducting material, preferably a cable shoe.

An object of the present invention is to provide a connecting piece of electrically conducting material, preferably a cable shoe, that has a continuous compact flat end of electrically conducting material on which the electric arc acts during the soldering process in such a way that the arc does not come into direct contact with the workpiece, for example a rail, during the soldering process, and that the connecting piece together with the compact plate forms part of the temperature-controlled soldering process in which a soldering is obtained that is completely free of martensite underneath the soldered joint.

Another object of the present invention is to be able during the fabrication to press a solder material in the form of a clip on the connecting piece and also place a flux material between the connecting piece and the soldering clip during fabrication. This saves a workstage and solves the problem of soldering per se in the workplace.

Moreover, an advantage is that solder material does not need to be supplied from other units to the soldering joint per se in order firmly to solder the connecting piece, nor do the surfaces between the connecting piece and solder material need to be cleaned in a separate operation.

A significant advantage of pressing a solder material clip firmly on the underneath side during the fabrication of the connecting piece is that a uniform thickness is obtained on the soldering clip. This is shaped so that it is larger than the connecting piece per se, preferably a cable shoe, and projects beyond the edges of the latter. This forms a more solid and more complete assembly of the cable shoe and workpiece, and also prevents water penetrating by means of capillary forces between the cable shoe and the underlying workpiece, and in addition prevents corrosion. Penetrating water can have a deleterious effect on the mechanical strength of the soldered joint. In addition this can impair the electrical properties of the connection. Since the soldering clip is larger than the cable shoe a larger joint surface is formed, which in turn produces a smaller electrical contact resistance.

In railway signal and cathode protection systems that operate at low voltages and currents it is particularly important to have a low overall contact resistance in the soldered joints in order to prevent interferences in the system. With large currents and voltages a high contact resistance leads to the evolution of heat in the soldered joint, which may damage and/or melt the latter. Since the connection also has to withstand high return currents in the railway operations system it is important to have a low contact resistance in the soldered joint.

For a similar reason it is also important that the contact resistance is low in protective earthings.

A further advantage of this new soldering process is that the rail does not need to be earthed during the soldering. In the soldering process the electrode serves as one pole of the arc and the other pole is formed by the electrically conducting connecting piece, for example a cable shoe. In this case the electrically conducting connecting piece forms the negative pole, conventionally called the connection in earthing terminology. In the present invention the electrode may form the positive pole or negative pole, or alternately positive/negative pole. It is an advantage not to use the rail as a pole since secondary arcs may be formed between the cable shoe and rail, which may have a negative effect on the rail in the form of martensite formation. Moreover, by excluding the rail from the closed electrical circuit the cause of possible interfering signals in the rail and apparatus connected thereto is eliminated. The use of the cable shoe as one pole also eliminates a workstage and in certain situations earthing equipment associated with the soldering. The cable shoe can be connected to the electrical circuit via the guard ring in the soldering gun or via the cable connected to the cable shoe.

Another object of the present invention is that carbon powder from the carbon electrode is released during the soldering process and is deposited on the upper surface of the electrically conducting connecting piece, for example a cable shoe, and prevents the formation of a cavity in the cable shoe during the soldering procedure. In addition the electric arc is established between two carbon poles, which has a stabilising effect on the arc and counteracts the tendency of the current to fall over time. Furthermore the carbon has thermally insulating properties and exerts a temperature distributing function. The carbon powder from the carbon electrode consequently also acts as a buffer material, thereby preventing too high a temperature in for example the rail during the soldering process.

The characterising feature of the present invention is disclosed in the following claim.

The present invention will now be described in more detail hereinafter with reference to the accompanying drawings that show various embodiments of the invention, in which

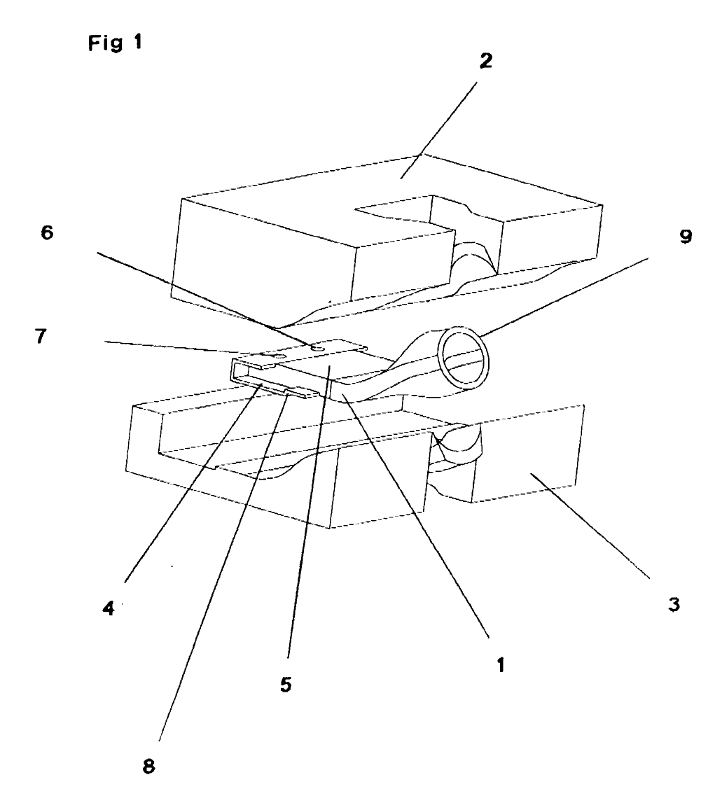

FIG. 1 shows a fabrication tool for producing a connecting piece of electrically conducting material and

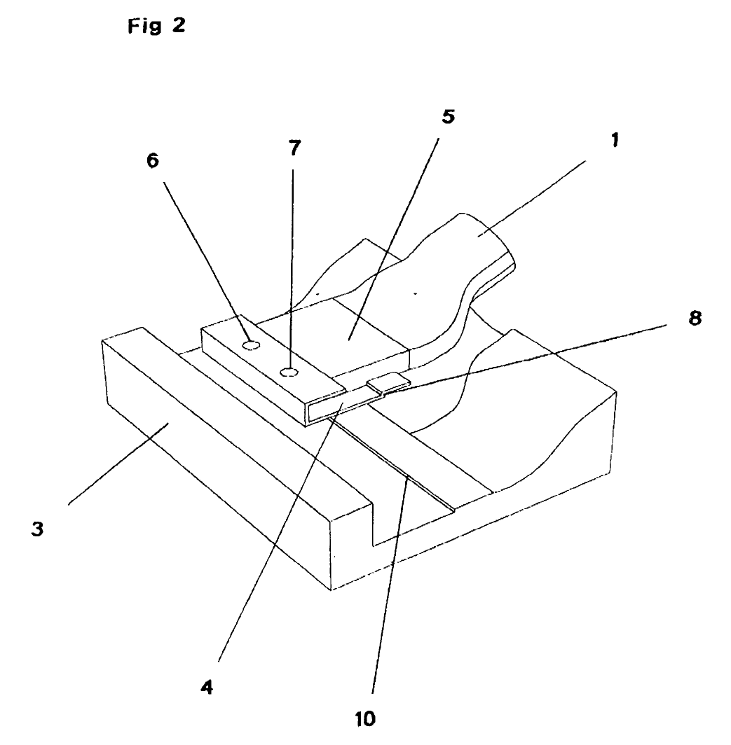

FIG. 2 shows the underneath part of the same fabrication tool.

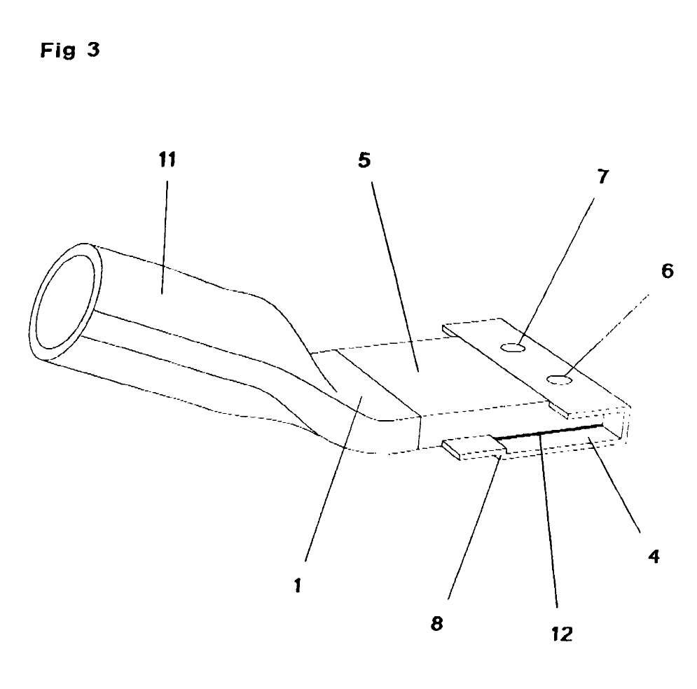

FIG. 3 shows a connecting piece in the form of a cable shoe and

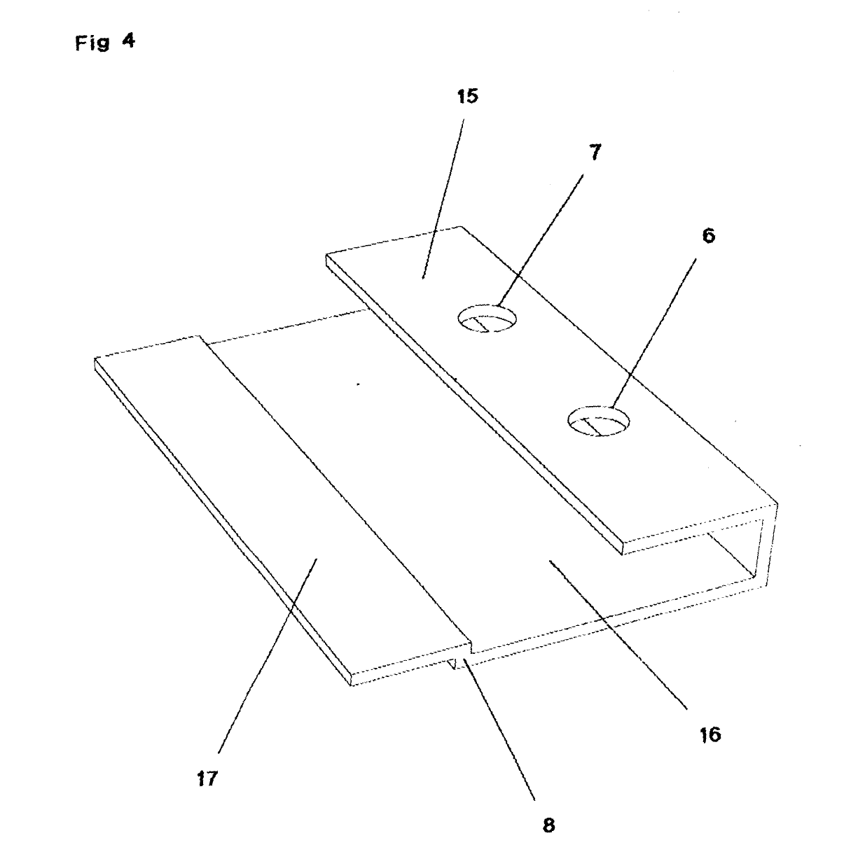

FIG. 4 shows a separate soldering clip after the latter has been pressed onto the connecting piece.

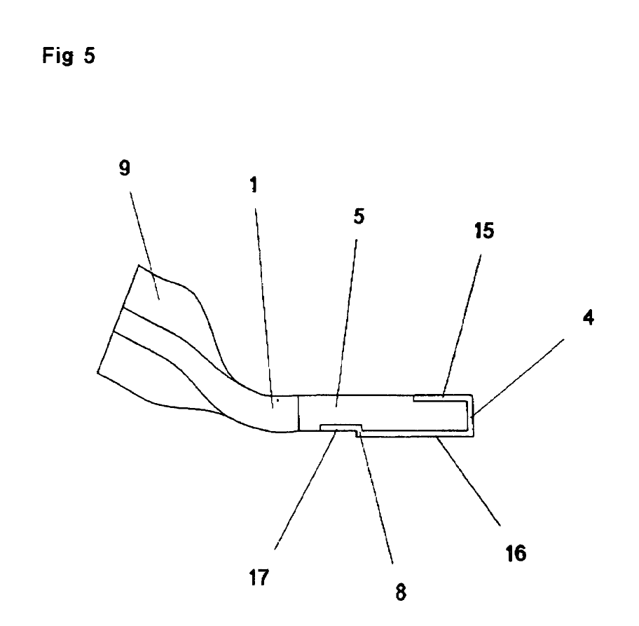

FIG. 5 is a side view of a finished connecting piece and

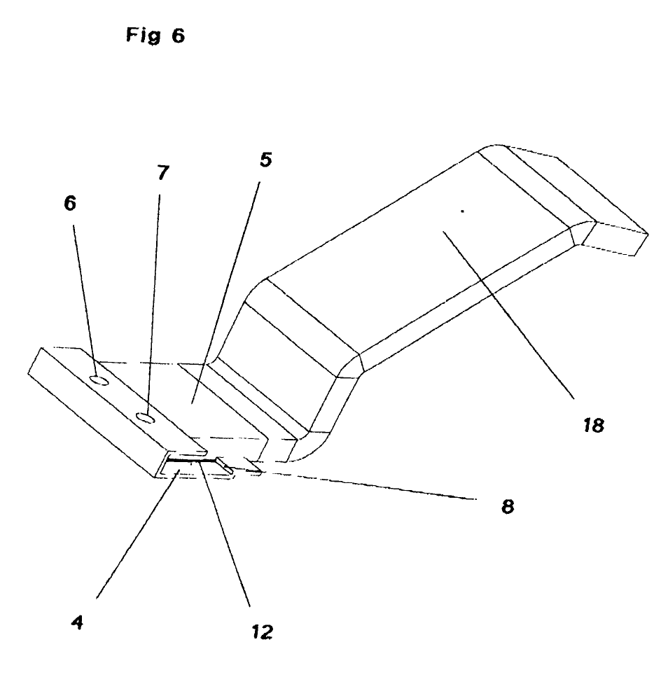

FIG. 6 shows a connecting piece of solderable material of a different design.

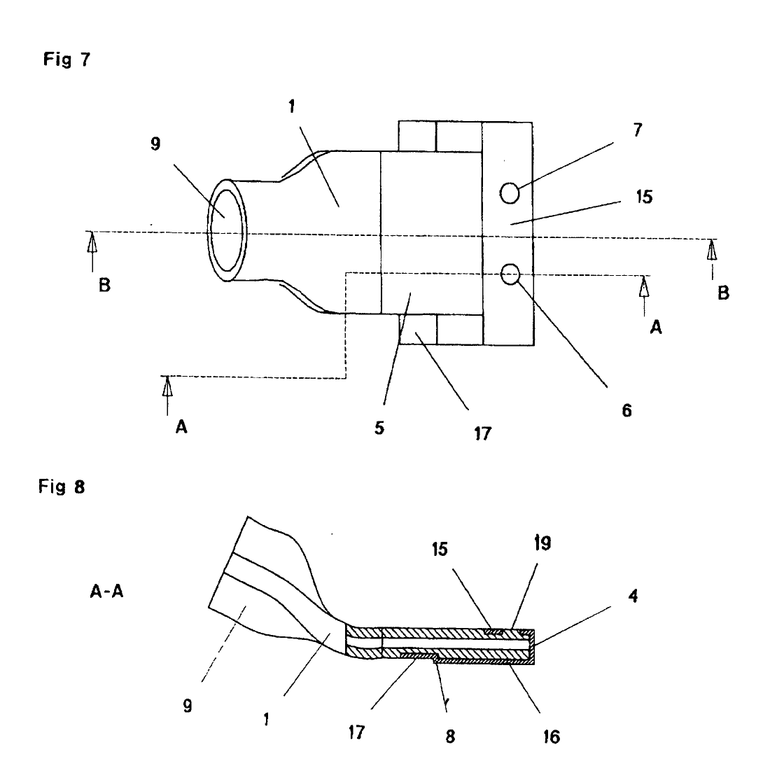

FIG. 7 shows the connecting piece/cable shoe from above, and

FIG. 8 shows the latter along the section A-A and

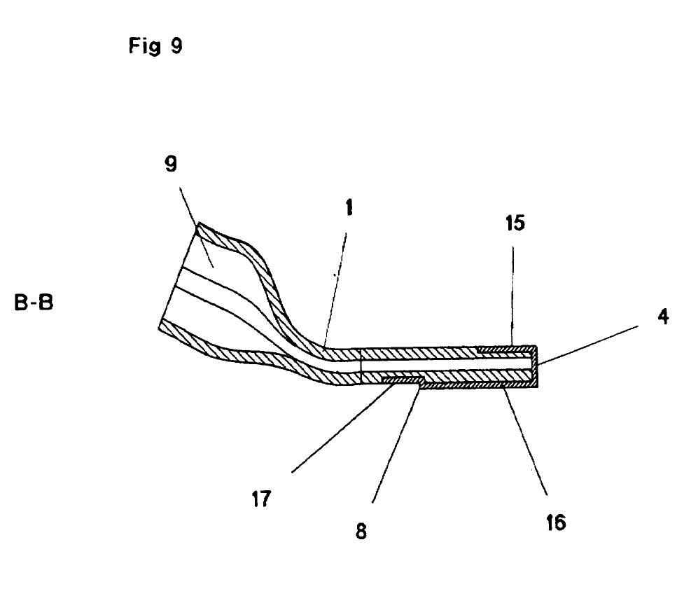

FIG. 9 along the section B-B.

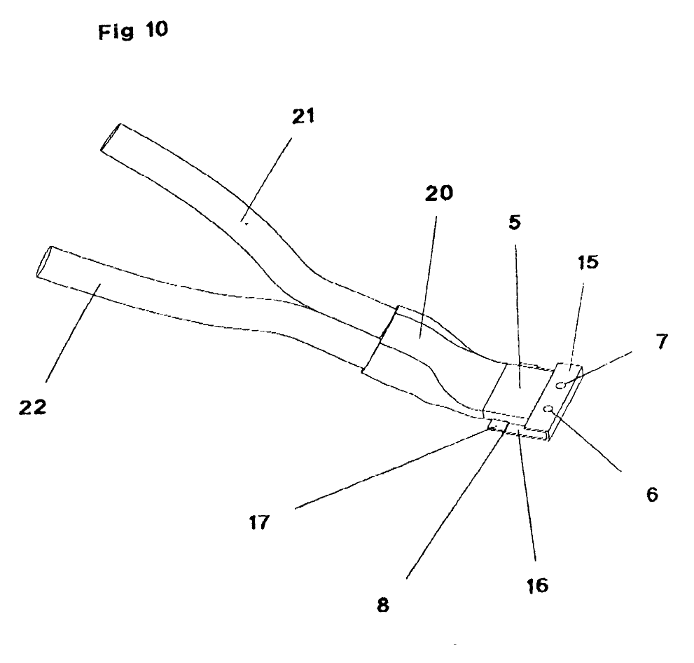

FIG. 10 illustrates the connecting piece of electrically conducting material by means of which two cables of electrically conducting material are joined together.

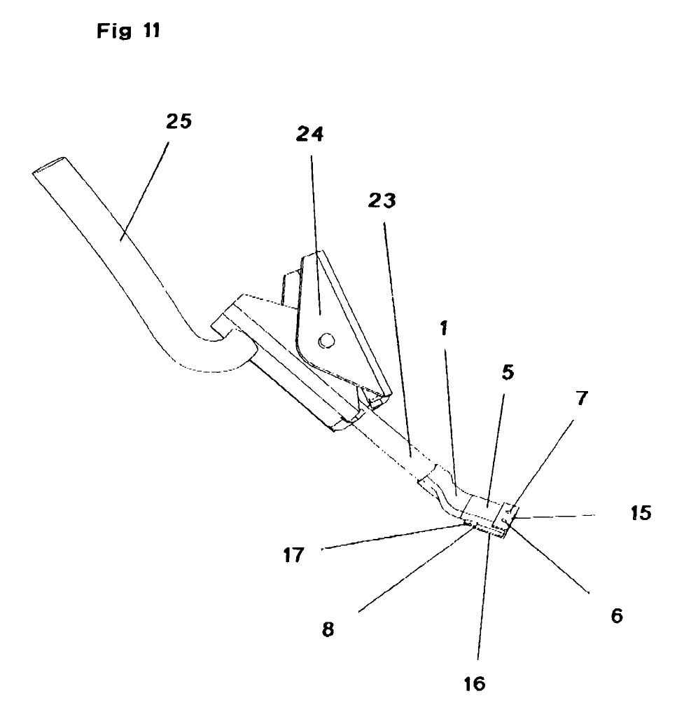

FIG. 11 shows the connecting piece plus cable with a coupled grounding contact.

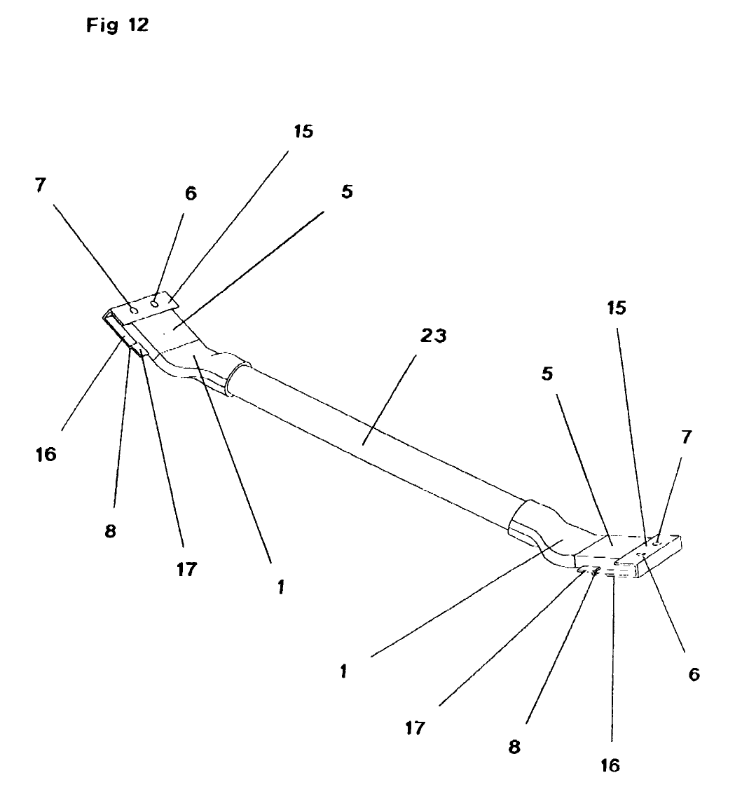

FIG. 12 is a view of a contact connection in which both ends are provided with a connecting piece in the form of a cable shoe. A variant of the securement of the soldering clip to the connecting piece is shown in

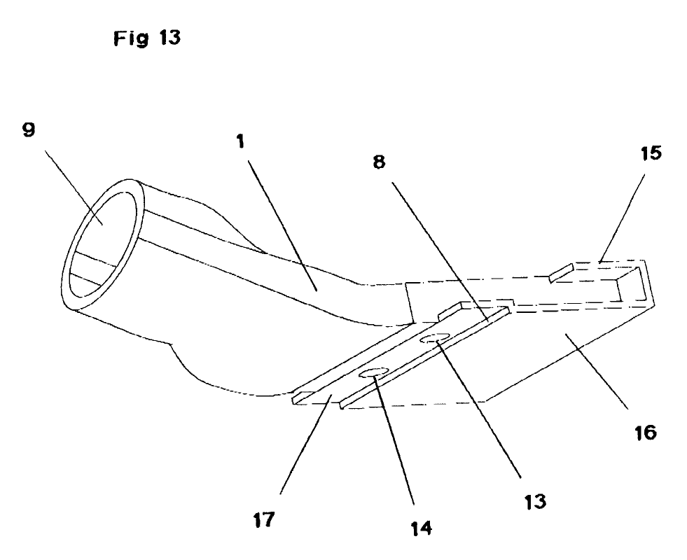

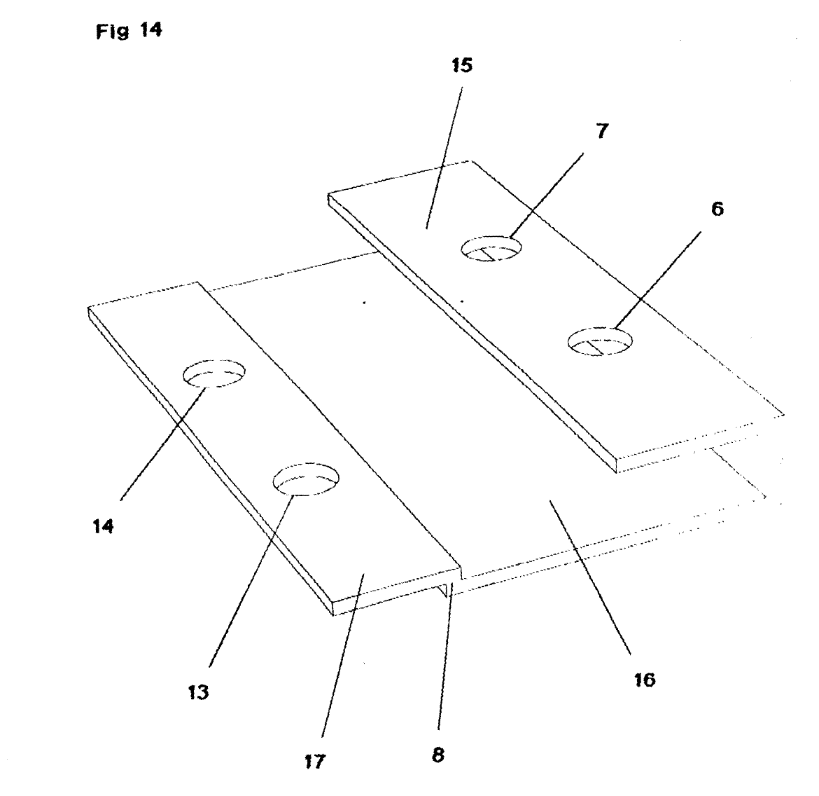

FIGS. 13 and 14, in which the soldering clip per se of this variant can be seen.

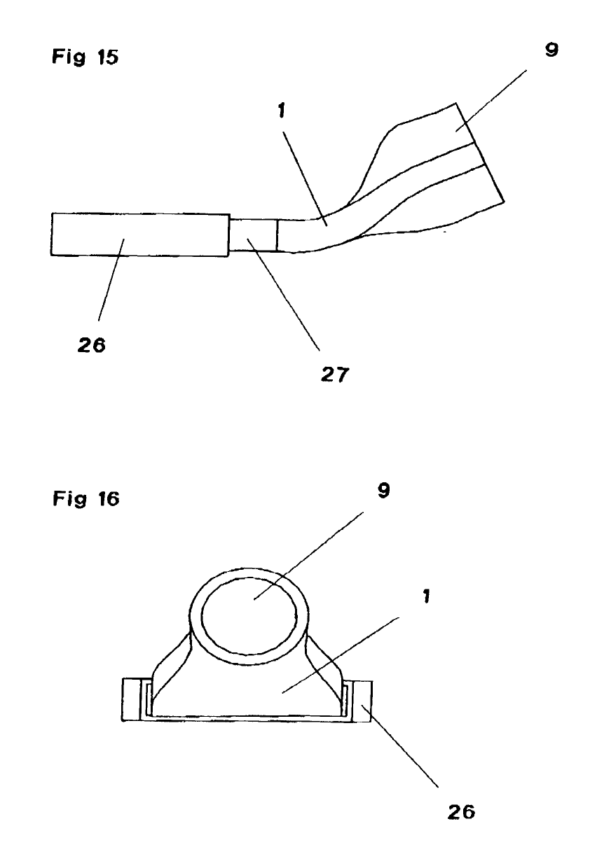

FIG. 15 shows a further variant of a soldering clip mounted on a cable shoe and

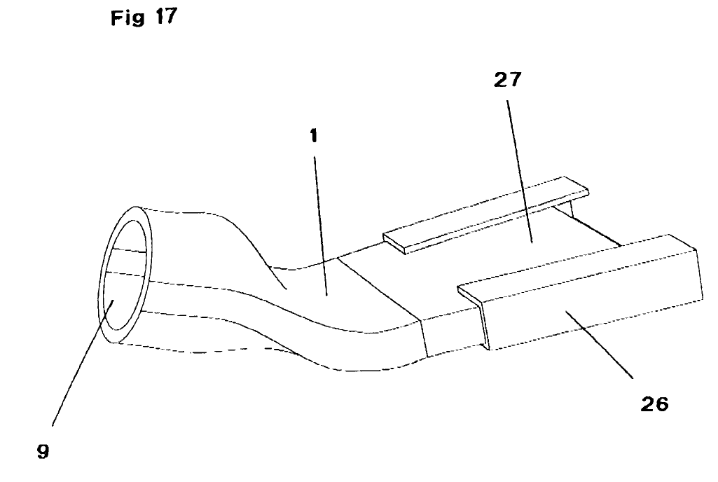

FIG. 16 shows the cable shoe itself plus soldering clip from the rear.

FIG. 17 is a view of the cable shoe itself seen obliquely from above.

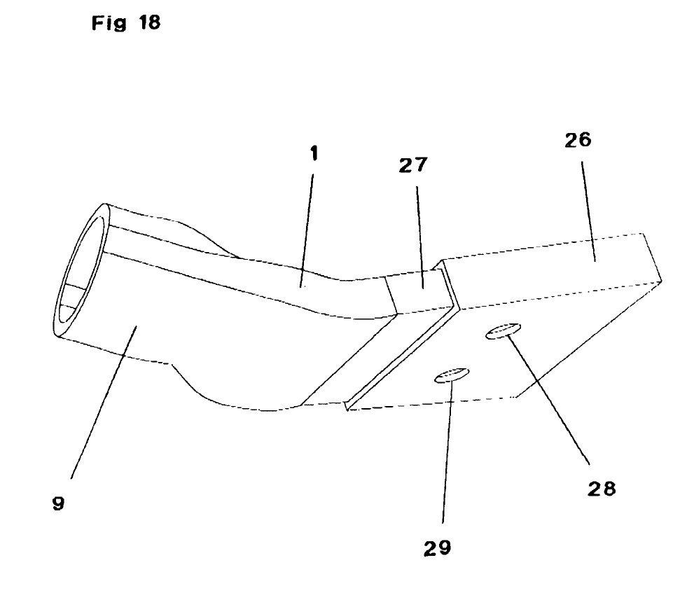

FIG. 18 is a view from below of the above variant of connecting piece plus soldering clip.

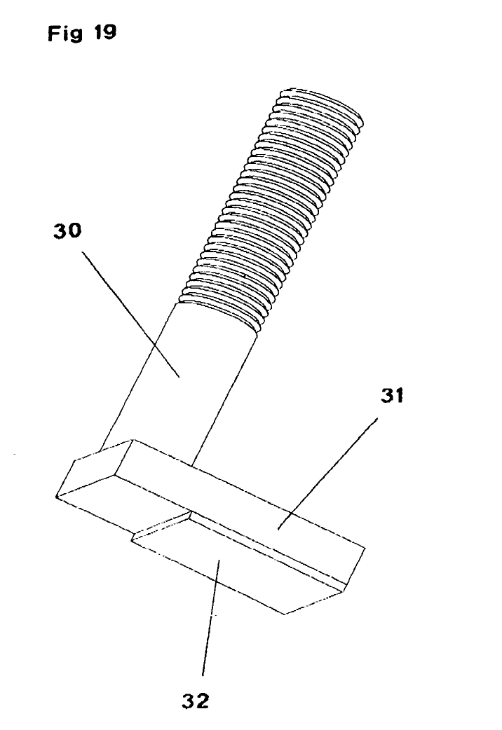

FIG. 19 shows a connecting piece of electrically conducting material with a bolt,

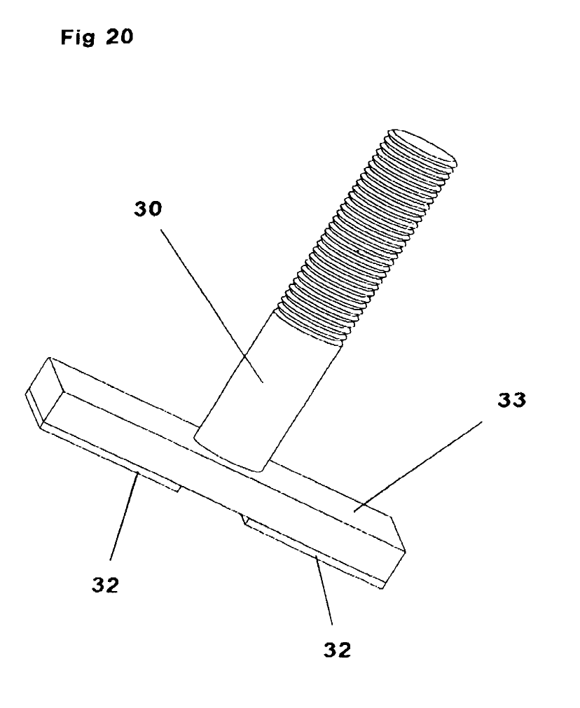

FIG. 20 shows a variant of a connecting piece with a bolt and

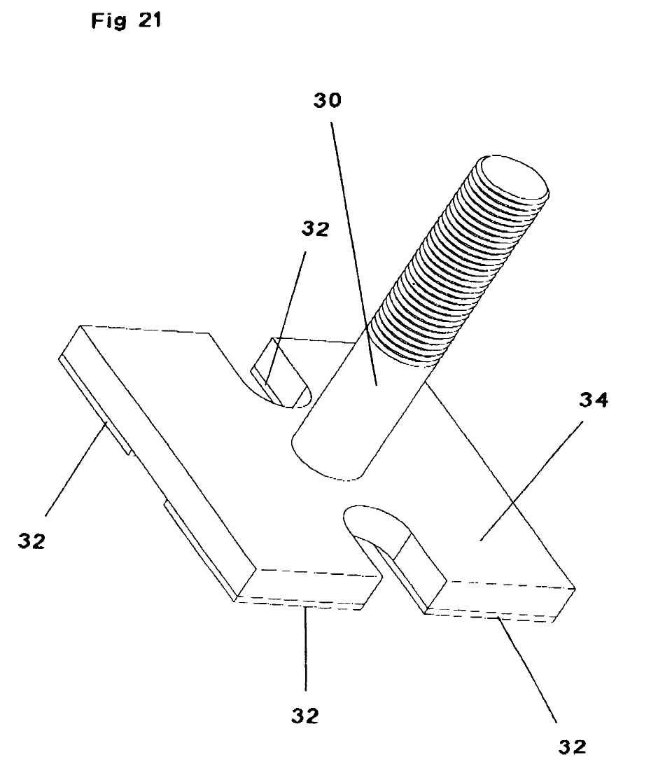

FIG. 21 shows yet a further variant of a connecting piece with a bolt.

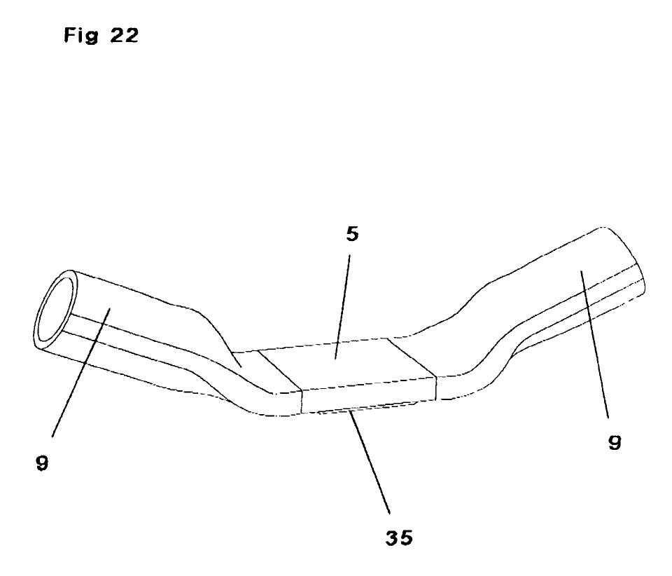

FIG. 22 shows an intermediate coupling piece.

FIG. 1 shows a fabrication tool for producing a connecting piece 1 of electrically conducting material around which is placed a solder material of uniform thickness, whereby when the upper part 2 (male part) of the tool is pressed against the lower part 3 (female part) of the tool a pressed-on soldering clip 4 is formed. An electrically conducting material in the form of a tube 9 is pressed between the upper part 2 and lower part 3 of the tool and forms a compact plate 5 of electrically conducting material against which the soldering clip 4, with flux material spread on at least one side, is pressed. The figure also shows that the soldering clip 4 is larger than the compact plate 5 and consequently the soldering clip 4 projects out around the compact plate 5. It can also be seen from the figure that the upper part of the soldering clip 4 is pressed down into the compact plate 5 and two holes 6 and 7, through which the underlying electrically conducting material passes, firmly secure the soldering clip 4 and preserve the flux material that is now contained between the soldering clip 4 and the compact plate 5. As regards the lower part of the soldering clip 4, only the part that is separated from the bevelled surface 8 penetrates the material of the connecting piece 1.

FIG. 2 shows the lower part 3 of the fabrication tool for producing a connecting piece 1 of electrically conducting material around which is placed a solder material of uniform thickness, which when pressed together form a pressed-on soldering clip 4. An electrically conducting material in the form of a tube when pressed together forms a compact plate 5 of electrically conducting material against which the soldering clip 4, coated on at least one side with flux material, is pressed. The figure also shows that the soldering clip 4 is larger than the compact plate 5 and accordingly the soldering clip 4 projects out around the compact plate 5. It can also be seen from the figure that the upper part of the soldering clip 4 is pressed down into the compact plate 5 and two holes 6 and 7, through which the underlying electrically conducting material passes, firmly secure the soldering clip 4 and preserve the flux material that is now contained between the soldering clip 4 and the compact plate 5. As regards the lower part of the soldering clip 4, only the part that is separated from the bevelled surface 8 penetrates the material of the connecting piece 1.

FIG. 3 shows a variant of a connecting piece 1 of electrically conducting material, preferably a cable shoe, with a tube part 11 of greater length into which is introduced a connecting member of electrically conducting material. The figure also shows the compact plate 5 of electrically conducting material which, in a completely new soldering process according to the invention, forms the unit on which acts the electric arc from the carbon electrode in a soldering gun. In the soldering process a carbon electrode is employed in which the carbon powder that is released from the carbon electrode is deposited as a thin layer on the compact plate 5 of the underlying connecting piece 1 and acts as a temperature buffer and heat distributor.

The overall result of the above arrangement is a soldering that is free from structural changes or martensite. Furthermore the electric arc is maintained between two carbon poles, which has a stabilising effect on the arc and counteracts the tendency of the current to vary over time.

The connecting piece 1 has at least one compact plate end 5 of electrically conducting material. The underneath side of the connecting piece 1 has a clip 4 of solder material that is secured for example by pressing it on during fabrication. The soldering process produces a soldered joint of larger area, which in turn produces a lower overall electrical contact resistance. A flux material 12 is located between the connecting piece 1 and soldering clip 4 and a flux material is also located between the soldering clip 4 and a workpiece, the flux material, solder material and soldering process being suitably adapted to. one another. The flux material 12 is suitable for soft soldering and is therefore active in a low temperature range, resulting in a martensite-free soldering.

A soldering that is carried out above ca. 500° C. is termed hard soldering, in contrast to soft soldering, which takes place at lower temperatures. The solder material and soldering clip 4 that are employed in the soldering process are suitable for hard soldering. Flux material that is suitable for hard soldering does not perform well in the new process since the latter takes place extremely quickly, in ca. 2 seconds. In the new soldering process a flux material is used that is suitable for soft soldering and is consequently activated at a lower temperature, but does not disintegrate before the soldering is completed, due to the short duration of the procedure. The figure also shows holes 6 and 7 for securing the soldering clip 4 and connecting piece 1, as well as the bevelled section 8.

FIG. 4 shows a separate soldering clip after it has been pressed on the connecting piece. The figure shows holes 6 and 7 on the upper side of the upper part 15 of the soldering clip 4. The figure also shows the lower part 16 on which is placed a flux material 12 that is incorporated between the connecting piece 1 and soldering clip 4. Behind a bevelled section 8 is a rear part 17 of the soldering clip 4 that is pressed into the connecting piece 1.

FIG. 5 is a side view of a connecting piece 1 of electrically conducting material with a tube part 9 and a compact plate 5 onto which a soldering clip 4 is pressed, and there can also be seen the upper part 15, lower part 16 and rear part 17 of the soldering clip 4, as well as the bevelled section 8. It can be seen from the figure that the soldering clip 4 has a uniform thickness.

FIG. 6 shows a connecting piece in the shape of a bracket of solderable material. In the figure there can be seen the compact plate 5 and also the flux material 12 that is incorporated between the compact plate 5 and soldering clip 4. Holes 6 and 7 for securement purposes and the bevelled section 8 can also be seen.

The connecting piece 1 in the form of a cable shoe is shown from above in FIG. 7. The figure shows the tube part 9 and soldering clip 4. It can also be seen from the figure that the soldering clip 4 is fashioned so that it is larger than the connecting piece 1 per se and its compact plate 5 projects from the edges. This creates a more secure and more complete assembly of the cable shoe and workpiece, and prevents water from penetrating by means of capillary forces between the cable shoe and the underlying workpiece, and in addition prevents corrosion. Penetrating water may adversely affect the mechanical strength of the soldered joint. In addition this can impair the electrical properties of the connection. Since the soldering clip is larger than the cable shoe a larger joint surface is created, which in turn leads to a lower electrical contact resistance. The figure also shows the rear part 17 and upper part 15 of the soldering clip 4 together with holes 6 and 7.

FIG. 8 is a section A-A of the above figure. This section shows penetrating material 19 in the hole in the soldering clip 4, together with its upper part 15, lower part 16 and rear part 17 as well as the bevelled section 8 and tube part 9 in the connecting piece 1.

FIG. 9 shows a section B-B of FIG. 7. The section shows the soldering clip 4 with its upper part 15, lower part 16 and rear part 17 as well as bevelled section 8, tube part 9 and connecting piece 1.

FIG. 10 illustrates the connecting piece of electrically conducting material, a so-called Y-shaped connecting piece, by means of which two cables of electrically conducting material are joined together. The figure shows the compact plate 5 together with the rear part 17, lower part 16 and upper part 15 of the soldering clip 4 and holes 6 and 7. Two other cables 21 and 22 of electrically conducting material form part of a multiple connecting piece 20 to which they are firmly soldered. The interior of the multiple connecting piece 20 is filled with a paste of flux material and solder material before the soldering stage.

FIG. 7 shows the connecting piece 1 together with a cable 23 with a coupled connecting clamp 24 and associated connection cable 25 constituting an earthing contact. The figure also shows the compact plate 5 together with the rear part 17, lower part 16 and upper part 15 of the soldering clip 4, and holes 6 and 7. Finally, the bevelled section 8 can also be seen.

In the new soldering process the electrode forms one pole or terminal of the arc and the other pole is formed by the connecting piece, for example a cable shoe. It is advantageous that the rail itself is not used as a pole since this can produce secondary arcs between the cable shoe and rail that can have deleterious effects on the latter in the form of martensite formation. Furthermore, by excluding the rail from the closed electrical circuit the occurrence of possible interference signals in the rail and apparatus connected thereto is eliminated. By using the cable shoe as one pole a workstage, and in certain situations earthing equipment and soldering associated therewith, are also eliminated. The cable shoe 1 may be connected to the electrical circuit via the cable 23 connected to the said cable shoe 1.

FIG. 12 is a view of a contact connection in which both ends are provided with connection pieces 1 in the form of cable shoes. The figure shows a cable 23 of electrically conducting material between two connecting pieces 1 in which each connecting piece 1 has a compact plate 5, and the soldering clip 4 comprises a rear part 17, lower part 16 and upper part 15 and holes 6 and 7 together with a bevelled section 8.

FIG. 13 is a view from below of the attachment of the soldering clip 4, with its parts 15, 16 and 17, to the connecting piece 1. Two holes 13 and 14 for penetrating material from the connecting piece 1 can be seen on the rear part 17 of the soldering clip 4. A tube part 4 can also be seen in the figure.

FIG. 14 shows the soldering clip 4 per se of the preceding figure, in which can be seen holes 6 and 7 on the upper part 15 of the soldering clip and holes 13 and 14 on the rear part 17 of the soldering clip, in which material from the connecting piece 1 is forced out by pressing together the soldering clip and the connecting piece. The bevelled section 8 and lower part 16 of the soldering clip can also be seen.

FIG. 15 is a further variant of a soldering clip secured to a cable shoe 1 with a tube section 9 and in which can be seen the pressed-on soldering clip 26 and an inwardly tapering compact plate 27.

FIG. 16 is a rear view of the cable shoe per se together with the soldering clip 26. The tube section 9 is also shown from the rear.

FIG. 17 is a view from above of the cable shoe 1 per se with a tube section 9. It can be seen from the figure that the soldering clip 26 is shaped so that it can be fitted onto the compact tapering plate 27.

FIG. 18 is a view from below of the above variant of connecting piece with the soldering clip 26, which is located on the compact plate 27. Two holes 28 and 29 are provided on the underneath of the soldering clip 26 that permit flux material to penetrate from the underlying workpiece. In this variant of connecting piece with soldering clip no flux material is incorporated between the latter. Consequently it is the flux material from the workpiece that penetrates upwardly and acts inside the soldering clip 26, melting the solder.

FIG. 19 shows a bolt-type connecting piece of electrically conducting material. The compact plate 31 that forms a single soldering joint as well as the underlying soldering plate 32 that may be fused thereon or may also be shaped as a clip can be seen in the figure. Finally, a bolt 30 is also shown.

FIG. 20 shows a bolt-type connecting piece with a double soldering joint, and there can be seen the bolt 30 in the middle of the compact plate 33 and two soldering plates 32 fused onto the underneath of the latter, which may also be shaped as clips.

FIG. 21 is yet a further variant of a connecting piece with a bolt forming a so-called bolt-type connecting piece. The figure shows a bolt 30 centred on the connecting piece 34. The figure also shows four soldering plates 32 that are either fused on or may be shaped as clips.

FIG. 22 is an intermediate coupling piece that shows a flat continuous compact plate 5 with a solder material 35 fused on underneath the plate, the solder material which may also be shaped as a clip; the figure also shows two tube parts 9.

The object of the present invention is to produce a connecting piece of electrically conducting material, preferably a cable shoe, consisting of a compact plate of electrically conducting material with a soldering clip of uniform thickness pressed or forced thereon, a flux material being incorporated between the latter so that the connecting piece is capable of being used in a new type of temperature-controlled soldering process, and in which the flux material, solder material and soldering process mutually co-operate. The soldering clip is larger than the compact plate and projects around its edges, which prevents penetration of water and also forms a larger joint surface that in turn produces a lower electrical contact resistance. The compact plate prevents the electric arc generated in the process acting directly on the workpiece and also avoids earthing the electrical circuit via the cable of the connecting piece, thereby preventing secondary arcs between the connecting piece and workpiece, for example a rail. The compact plate also collects the carbon powder that is released from the carbon electrode during the soldering process, which prevents the formation of a cavity in the cable shoe and has a stabilising effect on the arc. The overall result is that a soldering is produced that is free from martensite underneath the soldered joint.

Only some embodiments of the present invention have been illustrated in the drawings, but it should be pointed out that many other modifications are conceivable within the scope of the following claims.

1. Method for producing a new type of connecting piece of electrically conducting material, preferably a cable shoe, that is to be joined to another object of electrically conducting material by means of a temperature-controlled soldering process free from structural changes and martensite formation, characterised in that a tube (9) of electrically conducting material and a solder material suitable for hard soldering with an intermediate flux material (12) suitable for soft soldering are pressed between an upper part (2) of a tool and a lower part (3) of a tool so as to form a connecting piece (1) with a soldering clip (4) pressed thereon and an intermediately located flux material (12), and in which the soldering clip (4) consists of an upper part (15) with two holes (6, 7), a lower part (16) and a rear part with two holes (13, 14) and the soldering clip (4) is larger than a compact plate (5) in one part of the connecting piece (1), and that the soldering clip (4) is wholly of uniform thickness and that a bevelled section (8) separates the lower part (16) of the soldering clip (4) from its rear part (17).

2. Connecting piece, preferably a cable shoe, of electrically conducting material, that is to be joined by a temperature-controlled soldering process to a workpiece of electrically conducting material by means of a soldering free from structural changes and martensite formation, characterised in that the connecting piece (1) comprises at least one flat compact continuous plat (5) of electrically conducting material that collects carbon powder from a carbon electrode, that the electric arc generated in the soldering process acts on the compact plate (5), that a soldering clip (4) of uniform thickness is pressed onto the connecting piece (1), that a flux material (12) is incorporated between the connecting piece (1) and the soldering clip (4) of uniform thickness, that the soldering clip (4) is larger than the compact plate (5), and that four holes (6, 7, 13, 14) in the soldering clip (4) permit the soldering clip (4) to be pressed onto the connecting piece (1).

3. Connecting piece according to claim 2, characterised in that the soldering clip (4) can be pressed onto the compact plate (5) of the connecting piece (1).

4. Connecting piece according to claim 2, characterised in that a connecting piece (24) can be connected to a connecting cable (25) of the connecting piece (1) for earthing of the electrical circuit.

5. Connecting piece according to claim 2, characterised in that the soldering clip (4) may have two holes (28, 29) on the underneath to allow penetration of flux material.

6. Connecting piece according to claim 2, characterised in that a bolt (30) is provided on a compact plate (31, 33, 34) and solder material (32) is fused on the said compact plate (31, 33, 34).

7. Connecting piece according to claim 2, characterised in that there is no flux material between the connecting piece (1) and soldering clip (4).
